(19) United States
(12) Patent Application Publication
(10) Pub. No.: US 2021/0293084 A1
(43) Pub. Date: Sep. 23, 2021

(54) Garage Door Blind Assembly

(71) Applicant: Kiet Tran, Minneapolis, MN (US)

(72) Inventor: Kiet Tran, Minneapolis, MN (US)

(21) Appl. No.: 16/822,550

(22) Filed: Mar. 18, 2020

(51) Int. Cl. E06B 9/28; E06B 3/70

(52) U.S. Cl. CPC E06B 9/28; E05D 15/242; E06B 2003/7044; E06B 3/70

(57) ABSTRACT

A garage door blind assembly for selectively darkening or illuminating a garage includes a garage door that has a plurality of windows extending therethrough to pass sunlight therethrough. A plurality of sets of blinds is each of the sets of blinds is movably coupled to the garage door and each of the sets of blinds is aligned with a respective one of the windows. Each of the sets of blinds is positionable in a closed position to inhibit sunlight from passing through the respective window. Conversely, each of the sets of blinds is positionable in an open position to facilitate sunlight to pass through the respective window.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to door blind devices and more particularly pertains to a new door blind device for selectively darkening or illuminating a garage.

### (2) Description of Related Art Including Information Disclosed Under 37 CFR 1.97 and 1.98

The prior art relates to door blind devices. The prior art discloses a blind shutter that serves as an overhead door for a garage. Additionally, the prior art discloses a variety of window blinds that include a plurality of slats that are positionable between an open position or a closed position. The prior art also discloses a stacking mechanism for opening or closing a shutter. The prior art further discloses a horizontal garage door that comprises a plurality of hinged panels.

### BRIEF SUMMARY OF THE INVENTION

An embodiment of the disclosure meets the needs presented above by generally comprising a garage door that has a plurality of windows extending therethrough to pass sunlight therethrough. A plurality of sets of blinds is each of the sets of blinds is movably coupled to the garage door and each of the sets of blinds is aligned with a respective one of the windows. Each of the sets of blinds is positionable in a closed position to inhibit sunlight from passing through the respective window. Conversely, each of the sets of blinds is positionable in an open position to facilitate sunlight to pass through the respective window.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of a garage door blind assembly according to an embodiment of the disclosure.

FIG. 2 is a back view of an embodiment of the disclosure.

FIG. 3 is a detail view of a set of second blinds of an embodiment of the disclosure.

FIG. 4 is a cross sectional view taken along line 4-4 of FIG. 3 of an embodiment of the disclosure showing a set of blinds in a closed position.

FIG. 5 is a cross sectional view taken along line 4-4 of FIG. 3 of an embodiment of the disclosure showing a set of blinds in an open position.

FIG. 6 is a perspective in-use view of an embodiment of the disclosure.

FIG. 7 is a perspective view of a set of second blinds of an embodiment of the disclosure.

### DETAILED DESCRIPTION OF THE INVENTION

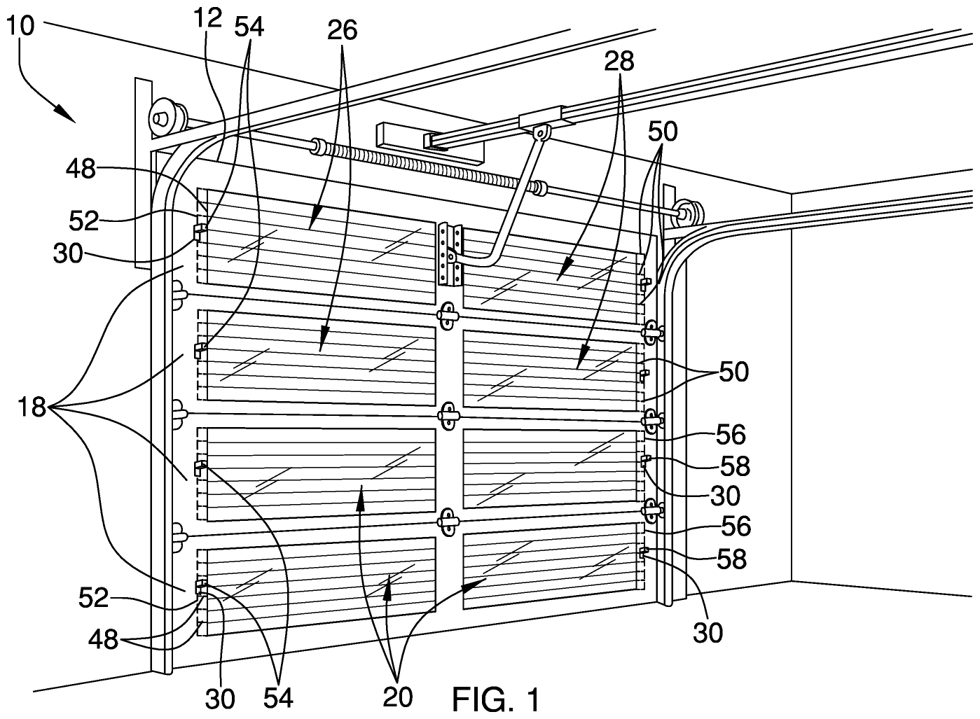

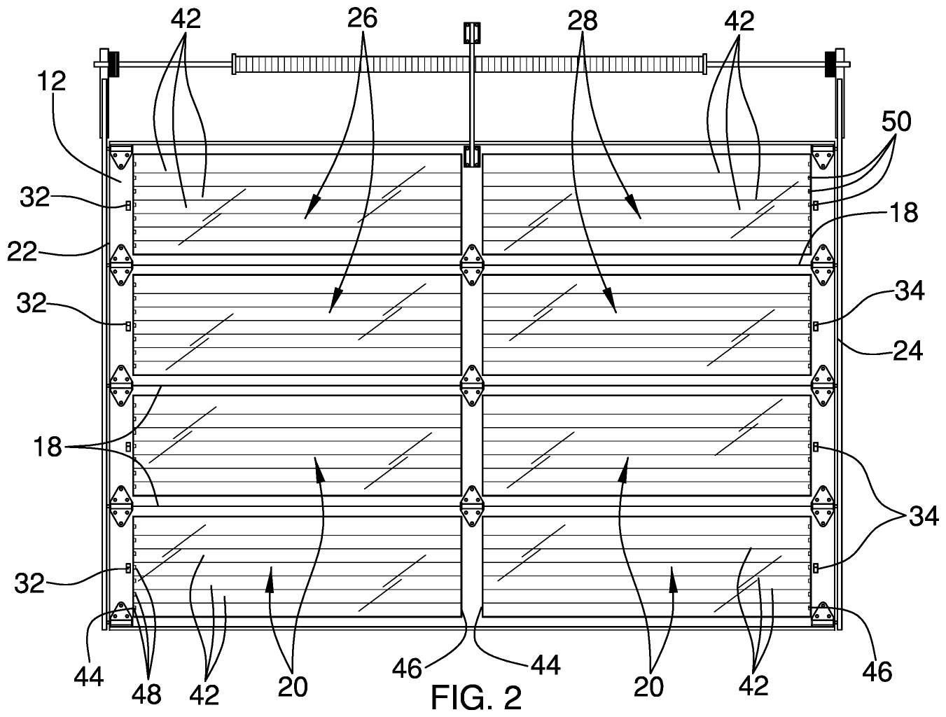

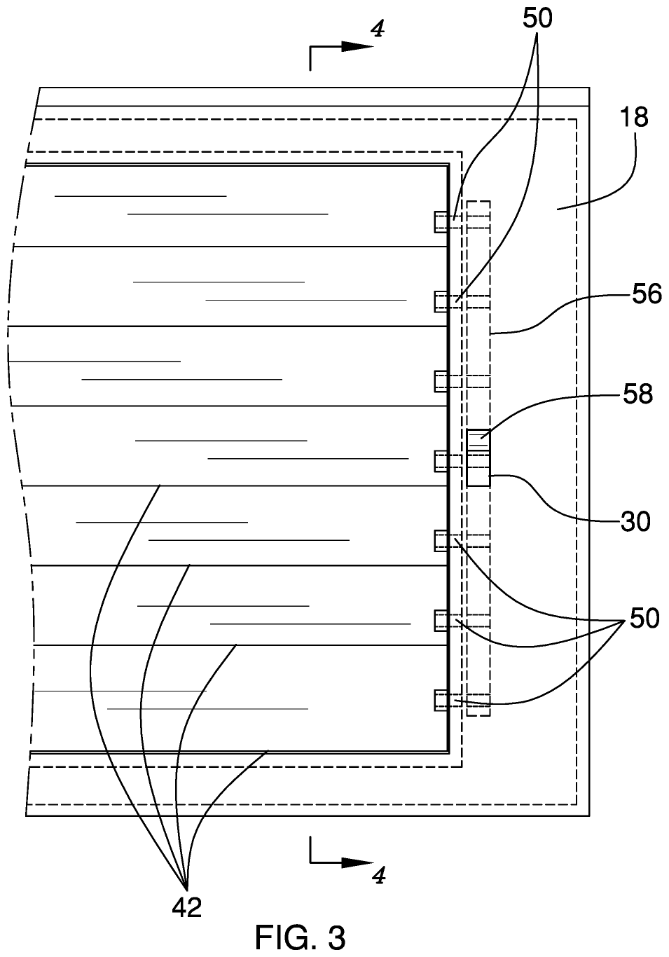

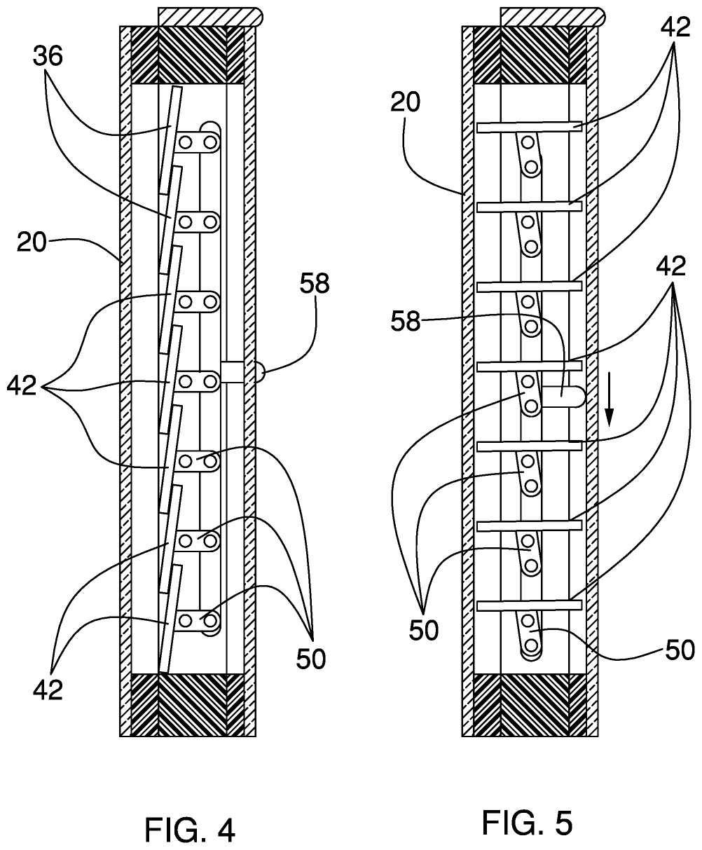

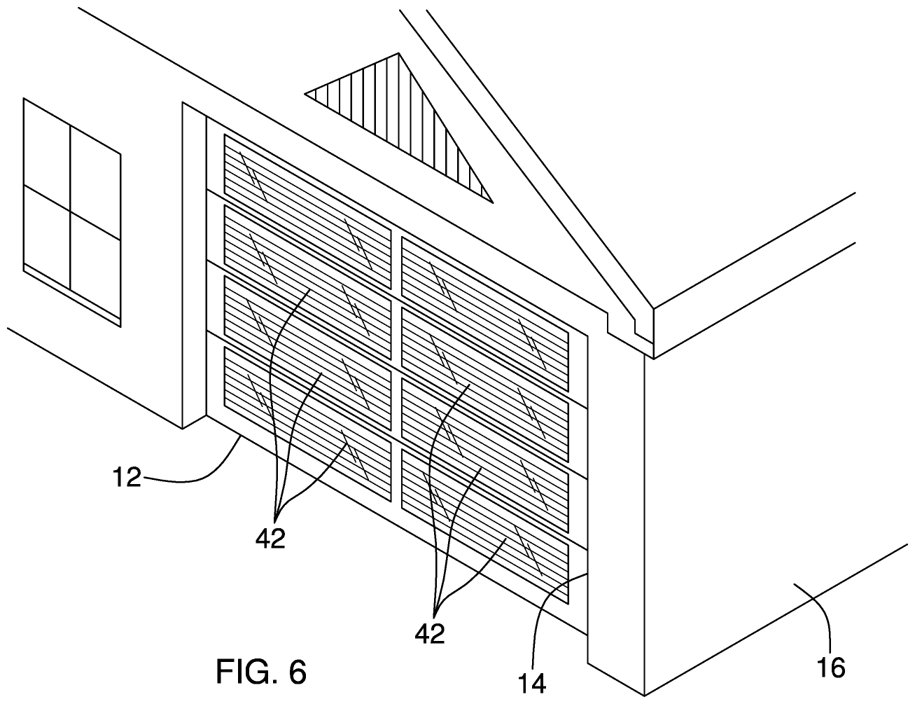

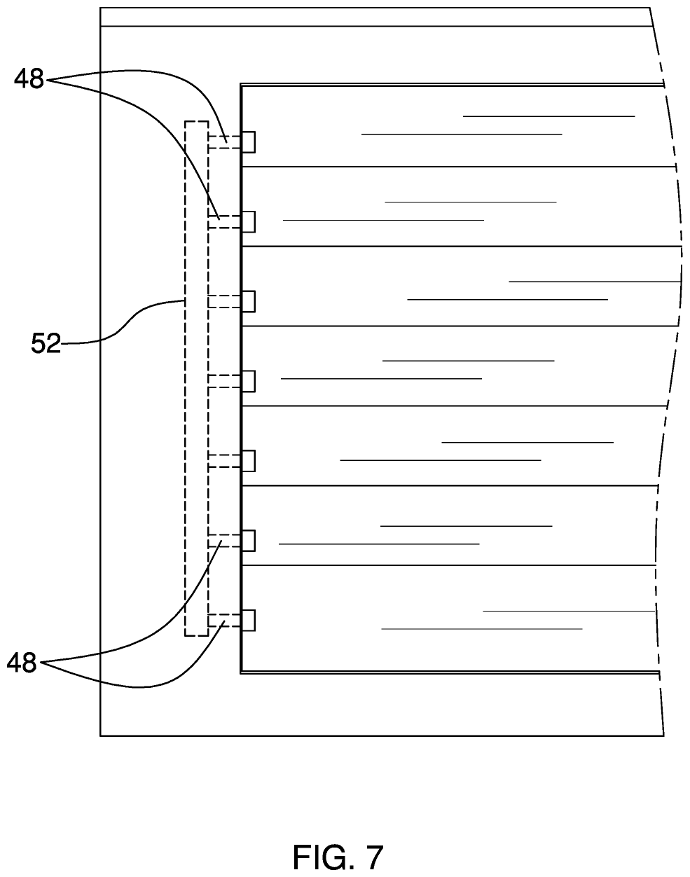

With reference now to the drawings, and in particular to FIGS. 1 through 7 thereof, a new door blind device embodying the principles and concepts of an embodiment of the disclosure and generally designated by the reference numeral 10 will be described.

As best illustrated in FIGS. 1 through 7, the garage door blind assembly 10 generally comprises a garage door 12 that is slidably positioned in a vehicle opening 14 of a garage 16. The garage door 12 is positionable between an open position and a closed position. The garage door 12 comprises a plurality of panels 18 being hingedly coupled together and each of the panels 18 has a plurality of windows 20 extending therethrough to pass sunlight into the garage 16. The garage 16 may be a garage on a house or the like, and the garage door 12 may include hardware, such as rails, rollers and an opener, that are common to existing overhead garage doors.

The garage door 12 has a first lateral edge 22 and a second lateral edge 24, and the plurality of windows 20 includes a set of first windows 26 and a set of second windows 28. Each of the first windows 26 is positioned adjacent to the first lateral edge 22 and each of the second windows 28 is positioned adjacent to the second lateral edge 24. The garage door 12 has a plurality of openings 30 each extending into an interior of the garage door 12, and the plurality of openings 30 includes a set of first openings 32 and a set of second openings 34. Each of the first openings 32 is aligned with a respective one of the first windows 26 and each of the second openings 34 is aligned with a respective one of the second windows 28. Moreover, each of the first openings 32 is positioned adjacent to the first lateral edge 22 of the garage door 12 and each of the second openings 34 is positioned adjacent to the second lateral edge 24 of the garage door 12.

A plurality of sets of blinds 36 is provided, each of the sets of blinds 36 is movably coupled to the garage door 12 and each of the sets of blinds 36 is aligned with a respective one of the windows 20. Each of the sets of blinds 36 is positionable in a closed position to inhibit sunlight from passing through the respective window 20. Conversely, each of the sets of blinds 36 is positionable in an open position to facilitate sunlight to pass through the respective window 20. The plurality of sets of blinds 36 includes a plurality of first sets of blinds 38 and a plurality of second sets of blinds 40. Each of the first sets of blinds 38 is positioned over a respective one of the first windows 26 and each of the second sets of blinds 40 is positioned over a respective one of the second windows 28.

Each of the sets of blinds 36 comprises a plurality of slats 42 that each has a first end 44 and a second end 46. Moreover, each of the slats 42 is elongated between the first end 44 and the second end 46 to a length that is at least equal to the length of the respective window 20. Each of the slats 42 is vertically stacked along a full height of the respective window 20. The first end 44 of the slats 42 corresponding to the first set of blinds 36 is aligned with the first lateral edge 22 of the garage door 12. The second end 46 of the slats 42 corresponding to the second set of blinds 36 is aligned with the second lateral edge 24 of the garage door 12.

Each of the first set of blinds 36 includes a set of first hinges 48 and each of the first hinges 48 is hingedly coupled between a respective pair of the slats 42 corresponding to the first set of blinds 36. Each of the first hinges 48 is positioned on the first end 44 of the respective slats 42 corresponding to the first set of blinds 36. Each of the second sets of blinds 40 includes a set of second hinges 50 and each of the second hinges 50 is hingedly coupled between a respective pair of the slats 42 corresponding to the second set of blinds 36. Each of the second hinges 50 is positioned on the second end 46 of the respective slats 42 corresponding to the second set of blinds 36.

The first set of blinds 36 includes a plurality of first couplings 52 and each of the first couplings 52 is movably positioned within the garage door 12. Each of the first couplings 52 is movably coupled to each of the first hinges 48 associated with a respective one of the first set of blinds 36. Each of the first couplings 52 urges the slats 42 of the respective first set of blinds 36 between the open position and the closed position. The first set of blinds 36 includes a plurality of first knobs 54 that is each coupled to and extends laterally away from a respective one of the first couplings 52. In this way each of the first knobs 54 moves the respective first coupling 52 for opening or closing each of the slats 42 corresponding to the first set of blinds 36. Additionally, each of the first knobs 54 extends outwardly through a respective one of the first openings 32 in the garage door 12 for being manipulated by a user.

The second set of blinds 36 includes a plurality of second couplings 56 and each of the second couplings 56 is movably positioned within the garage door 12. Each of the second couplings 56 is movably coupled to each of the second hinges 50 associated with a respective one of the second set of blinds 36. Each of the second couplings 56 urges the slats 42 of the respective second set of blinds 36 between the open position and the closed position.

The second set of blinds 36 includes a plurality of second knobs 58. Each of the second knobs 58 is coupled to and extends laterally away from a respective one of the second couplings 56. In this way each of the second knobs 58 moves the respective second coupling 56 for opening or closing each of the slats 42 corresponding to the second set of blinds 36. Each of the second knobs 58 extends outwardly through a respective one of the second openings 34 in the garage door 12 for being manipulated by the user.

In use, the garage door 12 is opened and closed in the traditional convention of garage doors. Any of the first knobs 54 or the second knobs 58 can be manipulated to open selected ones of the sets of blinds 36. In this way sunlight can pass through selected windows 20 to illuminate the garage 16 without requiring the garage door 12 to be opened. Thus, the garage 16 can be kept warm in the winter by facilitating sunlight to enter the garage 16 without opening the garage door 12. Conversely, any of the first knobs 54 or second knobs 58 can be manipulated to close selected ones of the sets of blinds 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A garage door blind assembly integrating a plurality of window blinds into a garage door for letting sunlight into a garage without opening the garage door, said assembly comprising:
a garage door being slidably positioned in an opening of a garage, said garage door being positionable between an open position and a closed position, said garage door comprising a plurality of panels being hingedly coupled together, each of said panels having a plurality of windows extending therethrough wherein each of said windows is configured to pass sunlight therethrough; and
a plurality of sets of blinds, each of said sets of blinds being movably coupled to said garage door, each of said sets of blinds being aligned with a respective one of said windows, each of said sets of blinds being positionable in a closed position wherein each of said sets of blinds is configured to inhibit sunlight from passing through said respective window, each of said sets of blinds being positionable in an open position wherein each of said sets of blinds is configured to facilitate sunlight to pass through said respective window.

2. The assembly according to claim 1, wherein said garage door has a first lateral edge and a second lateral edge, said plurality of windows including a set of first windows and a set of second windows, each of said first windows being positioned adjacent to said first lateral edge, each of said second windows being positioned adjacent to said second lateral edge.

3. The assembly according to claim 2, wherein said garage door has a plurality of openings each extending into an interior of said garage door, said plurality of openings including a set of first openings and a set of second openings, each of said first openings being aligned with a respective one of said first windows, each of said second openings being aligned with a respective one of said second windows, each of said first openings being positioned adjacent to said first lateral edge of said garage door, each of said second openings being positioned adjacent to said second lateral edge of said garage door.

4. The assembly according to claim 2, wherein said plurality of sets of blinds includes a plurality of first sets of blinds and a plurality of second sets of blinds, each of said first sets of blinds being positioned over a respective one of said first windows, each of said second sets of blinds being positioned over a respective one of said second windows.

5. The assembly according to claim 4, wherein each of said sets of blinds comprises a plurality of slats, each of said slats having a first end and a second end, each of said slats being elongated between said first end and said second end to a length being at least equal to the length of said respective window, each of said slats being vertically stacked along a full height of said respective window, said first end of said slats corresponding to said first set of blinds being aligned with said first lateral edge of said garage door, said second end of said slats corresponding to said second set of blinds being aligned with said second lateral edge of said garage door.

6. The assembly according to claim 5, wherein each of said sets of blinds includes a set of first hinges, each of said first hinges being hingedly coupled between a respective pair of said slats corresponding to said first set of blinds, each of said first hinges being positioned on said first end of said respective slats corresponding to said first set of blinds.

7. The assembly according to claim 6, wherein each of said sets of blinds includes a set of second hinges, each of said second hinges being hingedly coupled between a respective pair of said slats corresponding to said second set of blinds, each of said second hinges being positioned on said second end of said respective slats corresponding to said second set of blinds.

8. The assembly according to claim 6, wherein each of said sets of first blinds includes a plurality of first couplings, each of said first couplings being movably positioned within said garage door, each of said first couplings being movably coupled to each of said first hinges, each of said first couplings urging said slats of said respective first set of blinds between said open position and said closed position.

9. The assembly according to claim 8, wherein:
said garage door has a plurality of first openings each extending into an interior of said garage door; and
each of said sets of first blinds includes a plurality of first knobs, each of said first knobs being coupled to and extending laterally away from a respective one of said first couplings such that each of said first knobs moves said respective first coupling for opening or closing each of said slats corresponding to said first set of blinds, each of said first knobs extending outwardly through a respective one of said first openings in said garage door wherein each of said first knobs is configured to be manipulated by a user.

10. The assembly according to claim 7, wherein:
said garage door has a plurality of first openings each extending into an interior of said garage door, said garage door having a plurality of second openings each extending into said interior of said garage door;
each of said sets of first blinds includes a plurality of first couplings; and
each of said sets of second blinds includes a plurality of second couplings, each of said second couplings being movably positioned within said garage door, each of said second couplings being movably coupled to each of said second hinges, each of said second couplings urging said slats of said respective second set of blinds between said open position and said closed position.

11. The assembly according to claim 10, wherein each of said second blinds includes a plurality of second knobs, each of said second knobs being coupled to and extending laterally away from a respective one of said second couplings such that each of said second knobs moves said respective second coupling for opening or closing each of said slats corresponding to said second set of blinds, each of said second knobs extending outwardly through a respective one of said second openings in said garage door wherein each of said second knobs is configured to be manipulated by a user.

12. A garage door blind assembly integrating a plurality of window blinds into a garage door for letting sunlight into a garage without opening the garage door, said assembly comprising:
a garage door being slidably positioned in an opening of a garage, said garage door being positionable between an open position and a closed position, said garage door comprising a plurality of panels being hingedly coupled together, each of said panels having a plurality of windows extending therethrough wherein each of said windows is configured to pass sunlight therethrough, said garage door having a first lateral edge and a second lateral edge, said plurality of windows including a set of first windows and a set of second windows, each of said first windows being positioned adjacent to said first lateral edge, each of said second windows being positioned adjacent to said second lateral edge, said garage door having a plurality of openings each extending into an interior of said garage door, said plurality of openings including a set of first openings and a set of second openings, each of said first openings being aligned with a respective one of said first windows, each of said second openings being aligned with a respective one of said second windows, each of said first openings being positioned adjacent to said first lateral edge of said garage door, each of said second openings being positioned adjacent to said second lateral edge of said garage door; and
a plurality of sets of blinds, each of said sets of blinds being movably coupled to said garage door, each of said sets of blinds being aligned with a respective one of said windows, each of said sets of blinds being positionable in a closed position wherein each of said sets of blinds is configured to inhibit sunlight from passing through said respective window, each of said sets of blinds being positionable in an open position wherein each of said sets of blinds is configured to facilitate sunlight to pass through said respective window, said plurality of sets of blinds including a plurality of first sets of blinds and a plurality of second sets of blinds, each of said first sets of blinds being positioned over a respective one of said first windows, each of said second sets of blinds being positioned over a respective one of said second windows, each of said sets of blinds comprising:
a plurality of slats, each of said slats having a first end and a second end, each of said slats being elongated between said first end and said second end to a length being at least equal to the length of said respective window, each of said slats being vertically stacked along a full height of said respective window, said first end of said slats corresponding to said first set of blinds being aligned with said first lateral edge of said garage door, said second end of said slats corresponding to said second set of blinds being aligned with said second lateral edge of said garage door;
a set of first hinges, each of said first hinges being hingedly coupled between a respective pair of said slats corresponding to said first set of blinds, each of said first hinges being positioned on said first end of said respective slats corresponding to said first set of blinds;
a set of second hinges, each of said second hinges being hingedly coupled between a respective pair of said slats corresponding to said second set of blinds, each of said second hinges being positioned on said second end of said respective slats corresponding to said second set of blinds;
a plurality of first couplings, each of said first couplings being movably positioned within said garage door, each of said first couplings being movably coupled to each of said first hinges, each of said first couplings urging said slats of said respective first set of blinds between said open position and said closed position;
a plurality of first knobs, each of said first knobs being coupled to and extending laterally away from a respective one of said first couplings such that each of said first knobs moves said respective first coupling for opening or closing each of said slats corresponding to said first set of blinds, each of said first knobs extending outwardly through a respective one of said first openings in said garage door wherein each of said first knobs is configured to be manipulated by a user;
a plurality of second couplings, each of said second couplings being movably positioned within said garage door, each of said second couplings being movably coupled to each of said second hinges, each of said second couplings urging said slats of said respective second set of blinds between said open position and said closed position; and
a plurality of second knobs, each of said second knobs being coupled to and extending laterally away from a respective one of said second couplings such that each of said second knobs moves said respective second coupling for opening or closing each of said slats corresponding to said second set of blinds, each of said second knobs extending outwardly through a respective one of said second openings in said garage door wherein each of said second knobs is configured to be manipulated by a user.
